(19) United States
(12) Patent Application Publication
(10) Pub. No.: US 2024/0067844 A1
(43) Pub. Date: Feb. 29, 2024

(54) POLYOL SOLUTION FOR COATED CAPILLARIES IN CAPILLARY ISOELECTRIC FOCUSING

(71) Applicant: DH Technologies Development Pte. Ltd., Singapore (SG)

(72) Inventor: Pei-Hsun Wei, Concord (CA)

(21) Appl. No.: 18/271,608

(22) PCT Filed: Jan. 13, 2022
(86) PCT No.: PCT/IB2022/050260

§ 371 Date: Jul. 10, 2023

Related U.S. Application Data
(60) Provisional application No. 63/136,883, filed on Jan. 13, 2021.

(51) Int. Cl. C09D 171/08; G01N 30/60

(52) U.S. Cl. CPC C09D 171/08; G01N 30/60

(57) ABSTRACT

The disclosure provides a series of polyol solutions that are useful in capillary gel electrophoresis methods and compositions of matter (e.g., capillaries, capillary cartridges, and kits). The polyol solutions can maintain, protect, and improve capillary integrity and useful lifespan, polymer coating rehydration characteristics, avoid damage to polymer coatings, and increase the consistency in capillary performance between multiple separations.

### RELATED APPLICATIONS

This application claims the benefit of priority from U.S. Provisional patent application Ser. No. 63/136,883, filed on Jan. 13, 2021, the entire contents of which is hereby incorporated by reference herein.

### FIELD

This application relates to coated capillaries and their storage and usage with capillary isoelectric focusing.

### BACKGROUND

Capillary Isoelectric Focusing (cIEF) is a high-resolution analytical separation technique based on the isoelectric point of charged molecules. Commercially available capillaries used in cIEF applications are typically manufactured, stored, and shipped pre-filled with cIEF media and are sealed (e.g., gel-filled capillaries with end-caps or other seal types). It is important to maintain the condition of the capillaries and capillary media during these phases, as the introduction of air to the capillary media (e.g., during manufacture, or via damage to/loss of a seal) can dry the media and adversely affect capillary performance and lifespan. Similarly, once the column is in use, the column performance, lifespan, and media integrity can be negatively affected by prolonged storage, poor column conditioning practices, and poor storage conditions. Alternative strategies that demand less end-user expertise and care-in-handling while ensuring the robustness and performance of capillary media would provide a significant advance to the technology. The disclosure provides a series of solutions that provide for robust column performance and media integrity even under harsh storage conditions, without having to rely on specific physical means or user expertise.

### SUMMARY

As described herein, the disclosure provides for a polyol solution that can extend the effective lifespan of media used capillary isoelectric focusing (cIEF). The inventors have identified that contacting a polymer-coated capillary with an amount of a polyol solution can increase the robustness of the media used in capillary isoelectric focusing in terms of its useful lifetime as well as its storage capacity.

In one aspect, the disclosure provides a solution comprising from about 5% to about 50% of a polyol that prolongs the storage lifetime and/or the useful lifetime of a coating on the interior surface of a polymer coated isoelectric focusing capillary tube.

In an aspect the disclosure provides a polymer-coated capillary comprising: a capillary tube having an interior surface and an exterior surface, a polymer coating on the interior surface of the capillary tube, and a solution comprising from about 5% to about 50% of a polyol that contacts the polymer coating. In some embodiments, the polymer-coated capillary is a neutral polymer-coated capillary.

In some embodiments, the polyol may comprise a low molecular weight polyol. In some further embodiments the polyol comprises a diol or a triol. In yet some further embodiments, the polyol comprises glycerol.

In some embodiments, the solution comprises a polyol in an amount that provides a solution viscosity of about 0.30 to 30.00 cP. In some embodiments, the amount of the polyol provides a solution viscosity of less than 40 cP, 35 cP, 30 cP, 25 cP, 20 cP, 15 cP, 10 cP, 5 cP, or less than 1 cP. In some further embodiments, the solution viscosity is measured within a temperature range of about 0° C. to about 100° C.

In some embodiments, the polymer-coated capillary comprises an internal diameter of about 0.1 to 3000 um. In some embodiments, the capillary comprises an internal diameter of less than 200 um.

In some embodiments, the polymer-coated capillary does not comprise an end cap or seal.

In another aspect, the disclosure provides a pre-assembled capillary cartridge comprising at least one polymer-coated capillary that comprises an interior surface and an exterior surface, a polymer coating on the interior surface, and a solution comprising from about 5% to about 50% of a polyol that contacts the polymer coating.

In embodiments, the pre-assembled capillary cartridge comprises at least one polymer-coated capillary that comprises unsealed ends. In some embodiments, the pre-assembled capillary cartridge comprises at least one polymer-coated capillary that comprises a neutral polymer. In some embodiments, the pre-assembled capillary cartridge comprises a plurality of polymer-coated capillaries.

In another aspect, the disclosure provides a method of manufacturing a polymer-coated capillary having improved storage capacity, the method comprising: providing a capillary tube having an interior surface and an exterior surface, wherein the capillary tube has a polymer coating on the interior surface, and contacting the polymer coating on the interior surface of the capillary tube with a solution comprising from about 5% to about 50% of a polyol.

In some embodiments, the method further comprises drying the interior of the polymer-coated capillary after contacting with the solution.

In another aspect, the disclosure provides a kit comprising a polymer-coated capillary; a solution comprising from about 5% to about 50% of a polyol; and instructions for use. In some embodiments, the kit comprises a pre-assembled capillary cartridge that comprises at least one polymer-coated capillary; a solution comprising from about 5% to about 50% of a polyol; and instructions for use.

In further embodiments of any of the above aspects and embodiments, the solution comprises about 10% of the polyol and, in yet further embodiments, the polyol comprises glycerol.

Other aspects and embodiments will become apparent from the detailed description and illustrative embodiments and examples below.

### BRIEF DESCRIPTION OF DRAWINGS

FIG. 1 depicts, for purposes of contrast, a set of separations that show failed capillary storage conditions where drying during storage causes damage to the capillary coating.

FIG. 2 depicts a series of cIEF separations using a neutral polymer-coated capillary with dynamic coating with (PEO) during runs.

FIG. 3 depicts a separation run for peptide pI markers using a PEO column in accordance with example embodiments of the disclosure that shows elution of the markers during the focusing step under accelerated shelf life storage conditions.

FIG. 4 depicts cIEF separation experiments using a neutral polymer-coated capillary and polyol solution in accordance with the aspects and example embodiments of the disclosure.

FIG. 5A-5K depicts a series of over 200 cIEF separations using a neutral polymer-coated capillary and polyol solution in accordance with the aspects and example embodiments of the disclosure.

FIG. 6 depicts a cross-sectional view of a capillary in accordance with the present teachings.

FIG. 7 depicts a cartridge using a plurality of capillaries in accordance with the teachings herein.

### DETAILED DESCRIPTION

In a general sense, the disclosure provides a series of storage solutions that find use in capillary columns, and capillary isoelectric focusing in particular. The storage solutions in accordance with the disclosure help to avoid problems sometimes associated with capillary manufacturing, shipping, and storage and that can result in non-functional capillaries or capillaries that have shortened useful lifespan. The polyol solutions can be incorporated into the column during manufacture, storage, or shipping, or can be incorporated by the end-user. The polyol solutions can be used in combination with any type of capillary polymer coating, media, or conditioning solutions. Accordingly, the storage solutions in accordance with the disclosure help improve capillary coating stability and run-life, even under harsh storage, shipping, and use conditions.

In some aspects, the disclosure provides an aqueous solution, which may be referred to herein alternatively as a “polyol solution,” “cIEF solution,” or as a “storage solution,” comprising a polyol in concentrations that are sufficient to increase the performance and/or functional characteristics of the coating in an isoelectric focusing capillary column.

In accordance with the aspects and example embodiments of the disclosure, a “polyol” comprises an organic compound having more than one hydroxyl functional groups. In some aspects and embodiments of the disclosure, the polyol (cIEF or storage) solution includes a polyol that may comprise two hydroxyl groups (diol), three hydroxyl groups (triol), four hydroxyl groups (tetrol), or more than four hydroxyl groups. In some further aspects and embodiments a polyol may be a low molecular weight polyol, including molecules that comprises a glycol moiety (e.g., ethylene glycol, propylene glycol, butanediol, etc.), a sugar alcohol, including sugar alcohols of the general formula HOCH₂(CHOH)ₙCH₂OH, wherein n is selected from 1, 2, 3, 4, 5, or 6, and which includes glycerol (propane-1,2,3-triol, (CH₂OH)₂CHOH) or molecules derived from glycerol, or branched polyols such as the non-limiting examples of trimethylolpropane (TMP) and pentaerythritol. Polyols in accordance with the disclosure can also encompass higher molecular weight polymeric polyols (e.g., polyether, polyester, and polyvinyl polyols), including non-limiting examples of polyethylene oxides, polyethylene glycols, polypropylene glycols, and polyvinyl alcohols. In some embodiments, polymeric polyols may comprise molecules of about 1000 carbon atoms or less, and are typically of an average molecular weight of no more than about 15,000 Da.

In some embodiments, the storage solution comprises polyol in an amount from about 5% to about 70% of the solution, by weight or by volume. In such embodiments, the polyol may be sufficiently soluble in aqueous solvent such that is can be prepared at a concentration within the stated ranges. In some embodiments the aqueous solvent may comprise an amount of one or more alcohols including, for example, primary, secondary, or tertiary alcohols (e.g., methanol, ethanol, propanols, butanols, or pentanols and the like). In some embodiments, the amount of the polyol in the cIEF solution provides a viscosity of the solution that ranges from about 1.05 to about 20 cP (at 20° C.). In further embodiments, the amount of the polyol provides a solution viscosity (at 20° C.) of about 1.1 to about 4.0 cP, including any particular viscosity and range of viscosities within that range (e.g., 1.2 cP, 1.3 cP, 1.4 cP, 1.5 cP, 1.6 cP, 1.7 cP, 1.8 cP, 1.9 cP, 2.0 cP, 2.1 cP, 2.2 cP, 2.3 cP, 2.4 cP, 2.5 cP, 2.7 cP, 3.0 cP, 1.1-1.7 cP, 1.2-2.0 cP, etc).

In some particular embodiments, the polyol comprises a low molecular weight polyol in an amount ranging from about 5% to about 50% (by weight or volume). In yet further embodiments, the storage solution comprises glycerol in an amount within a range of about 5% to about 50%, about 5% to about 40%, about 5% to about 30%, about 5% to about 25%, about 5% to about 20%, about 5% to about 15%, about 5% to about 10%, or about 5%, 6%, 7%, 8%, 9%, 10%, 11%, 12%, 13%, 14%, 15%, 16%, 17%, 18%, 19%, or 20%. In yet further embodiments, the low molecular weight polyol comprises glycerol in an amount as recited above.

In an aspect the disclosure provides a polymer-coated capillary comprising: a capillary tube having an interior surface and an exterior surface, a polymer coating on the interior surface of the capillary tube, and a storage solution comprising a polyol, in accordance with the aspects and embodiments of the disclosure, that contacts the polymer coating. In another aspect, the disclosure provides a pre-assembled capillary cartridge comprising at least one polymer-coated capillary that comprises a capillary tube having an interior surface and an exterior surface, a polymer coating on the interior surface of the capillary tube, and a storage solution comprising a polyol, in accordance with the aspects and embodiments of the disclosure, that contacts the polymer coating. In some embodiments of these aspects, the capillary may comprise a fused-silica type capillary. In embodiments, the internal surface of the fused-silica type capillary can be functionalized and/or pre-filled with separation gel. In embodiments, the capillary may be pre-treated using any number of typical pretreatment solutions as generally known in the art. In some embodiments the polymer-coated capillary may comprise a negative fused silica capillary or neutral polymer-coated capillary.

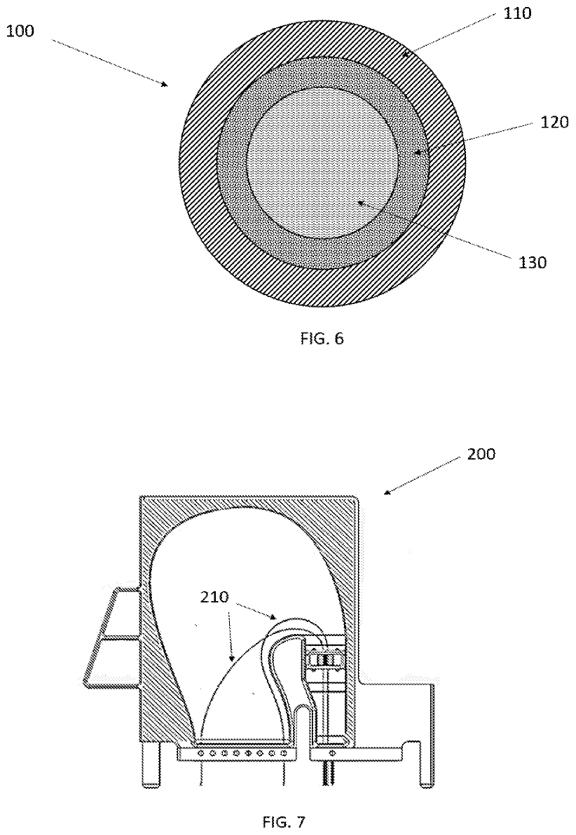

With reference to FIG. 6, a cross sectional view of polymer coated capillary 100 is depicted comprising a capillary tube 110 having an exterior surface and an interior surface, the interior surface having a polymer coating 120 disposed thereon. The polymer coated capillary is filled with a storage solution 130 in accordance with the present teachings that comprises a polyol that contacts the polymer coating on the interior of the coated capillary. In some embodiments, this solution can be optionally dried leaving a residual amount of the polyol sufficient to stabilize the polymer coating.

In some embodiments, the capillary comprises a polymer composition or a polymer composition in combination with an organic acid (an acidic polymer composition). In some aspects, the polymer comprises polyacrylamide, polyethylene oxide (PEO), polyethylene glycol (PEG), polyvinyl alcohol (PVA), polyvinylpyrrolidone (povidone, polyvidone, or PVP) or polyoxyethylene (POE) and derivatives thereof. In embodiments that include an organic acid, some embodiments comprise a carboxylic acid. In further embodiments, the carboxylic acid comprises at least one of acetic acid, lactic acid, formic acid, citric acid, oxalic acid, uric acid, malic acid, or tartaric acid. In still a further embodiment, the capillary can comprise an acidic polymer composition comprising about 1.0% (w/v) polyethylene oxide (PEO) and 4% (v/v) acetic acid (HAc). In some further embodiments, the PEO has a molecular weight of at least 900,000 Da.

In some embodiments, the capillary comprises dimensions that are typical for capillary electrophoresis applications. In some embodiments the capillary comprises an internal diameter ranging from about 20-250 μm, including any particular diameter and range of diameters within that range (e.g., 100 μm, 150 μm, 75 μm, 50-250 μm, 25-100 μm, 25-75 μm). In some embodiments the internal diameter may range from about 25 μm to no more than about 100 μm. In embodiments, the length of the capillary may vary, but is typically from about 1 cm to about 100 cm, including any particular length and range of lengths within that range (e.g., 100 cm, 50 cm, 75 cm, 1-5 cm, 1-10 cm, 50-80 cm, 25-100 cm, 45-75 cm, etc.).

In embodiments relating to a pre-assembled capillary cartridge, the cartridge comprises at least one polymer-coated capillary comprising a polyol solution in accordance with the embodiments of the disclosure. In some embodiments, the cartridge comprises a plurality of polymer coated capillaries (e.g., 2, 3, 4, 5, 6, 7, 8, 9, or 10 or more capillaries), in accordance with the aspects and embodiments of the disclosure.

With reference to FIG. 7, an internal view of a pre-assembled capillary cartridge 200 is depicted that can be used in accordance with the present teachings to carry out capillary isoelectric focusing when used as part of a complementary capillary electrophoresis device (not shown). The cartridge comprises a plurality of capillaries 210 (only two being shown).

In some embodiments, the capillary may comprise an optional endcap or seal at one or both terminal ends of the capillary. Thus, in embodiments, the disclosure provides a polymer-coated capillary, or a pre-assembled capillary cartridge, wherein the polymer-coated capillary does not include or comprise an end cap or seal. As described herein, and as illustrated by example embodiments, polyol solutions in accordance with the aspects and embodiments of the disclosure can improve the stability and run lifespan of a polymer-coated capillary under harsh conditions. Thus, the disclosure allows for the manufacture, production, storage, and shipping of a polymer-coated capillary as well as pre-assembled capillary cartridges comprising at least one polymer-coated capillary, that do not comprise an end cap or seal on the capillary. Further, the disclosure allows the end-user to use, maintain, and/or store a capillary, or pre-assembled capillary cartridge, without the need to cap or seal the ends of the capillary when not in use.

In another aspect, the disclosure provides a kit comprising a polymer-coated capillary and/or a pre-assembled capillary cartridge comprising at least one polymer-coated capillary; a polyol solution in accordance with the aspects and embodiments of the disclosure; and instructions for use. In embodiments, the instructions for use may comprise instructions for performing one or more of the methods in accordance with the aspects and embodiments that are described below. In some embodiments, the polymer-coated capillary contains the polyol solution in accordance with the present teachings on the interior of the capillary.

In other aspects, the disclosure provides methods that incorporate the polyol solutions in accordance with the aspects and embodiments described herein. In some embodiments the method relates to manufacturing a polymer-coated capillary having improved storage capacity, the method comprising: providing a capillary tube having an interior surface and an exterior surface, wherein the capillary tube has a polymer coating on the interior surface, and contacting the polymer coating on the interior surface of the capillary tube with a polyol solution in accordance with the aspects and embodiments of the disclosure. In some embodiments, the manufacturing method may comprise drying the interior of the polymer-coated capillary after contacting the capillary with the polyol solution, leaving a residual amount of polyol present to stabilize the polymer.

In other embodiments, the method relates to improving capillary isoelectric focusing (cIEF) robustness or performance, the method comprising providing a polymer-coated capillary and a polyol solution in accordance with the aspects and embodiments of the disclosure, and contacting the polymer coating on the interior surface of the capillary tube with the polyol solution.

In yet other embodiments, the method relates to improving the useful life span of a polymer-coated capillary, the method comprising providing a polymer-coated capillary and a polyol solution in accordance with the aspects and embodiments of the disclosure, and contacting the polymer coating on the interior surface of the capillary tube with the polyol solution.

In some embodiments of any of the above methods, the method may comprise a step selected from the group consisting of a storing step, a drying step, a rehydration step, a conditioning step, a rinse in separation step, a resting step, a cleaning step, a coating regeneration step, and a recoating step.

In some embodiments of any of the above methods, the capillary tube (e.g., polymer-coated capillary) may be contacted with a volume of polyol solution equivalent to one or more capillary column volumes (e.g. 0.5, 1, 2, 3, 4, 5, 6, 7, 8, 9, or 10 or more column volumes).

In embodiments of any of the above methods, the method may provide improved capillary performance that may be characterized based on measuring any one or more of: reduced column conditioning time; faster capillary absorption; minimized cIEF performance variations between capillaries between lots and within lots; minimized detection time fluctuations between replicate separations; minimized polymer coating damage during storage, shipping, or use; improved assay robustness; increased detection time reproducibility; increased wall life of the capillary; improved rehydration capacity; and improved performance after regeneration and/or rest periods.

### Examples

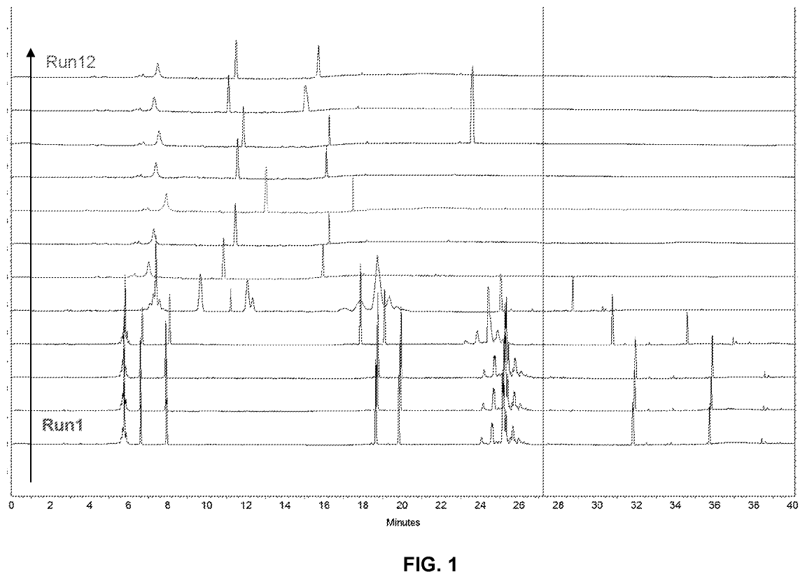

A series of experiments are conducted to assess various solutions in accordance with various aspects and embodiments of the disclosure and the effect those solutions have on various capillary columns. The first set of experiments establish a baseline level for the general robustness of a capillary comprising a pre-filled cIEF gel coating. A series (e.g., 12 runs) of column separations are performed using a prefilled cIEF gel capillary, where the prefilled capillary is allowed to dry out (e.g., to mimic a broken or faulty column seal or unintended drying). FIG. 1 demonstrates that the dried capillary fails to separate a set of peptide standard pI markers over the course of only 12 separations.

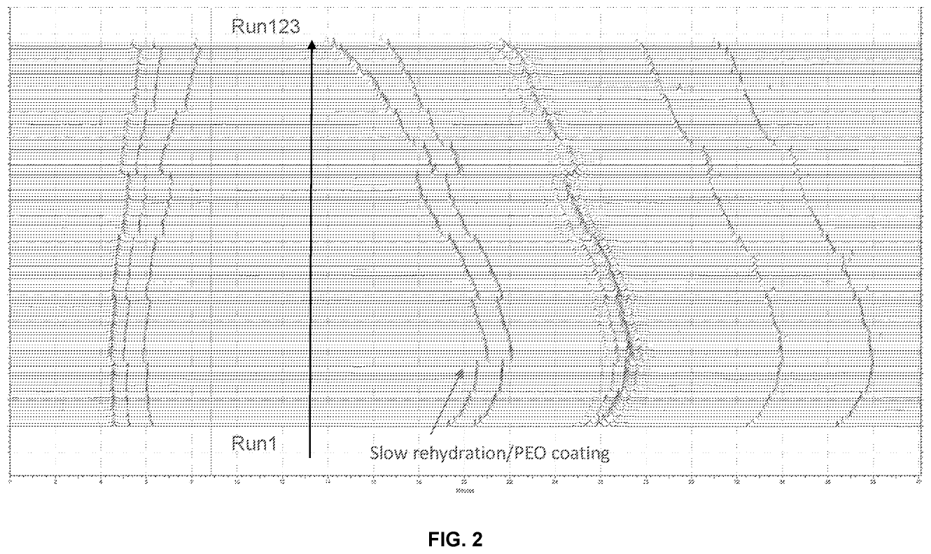

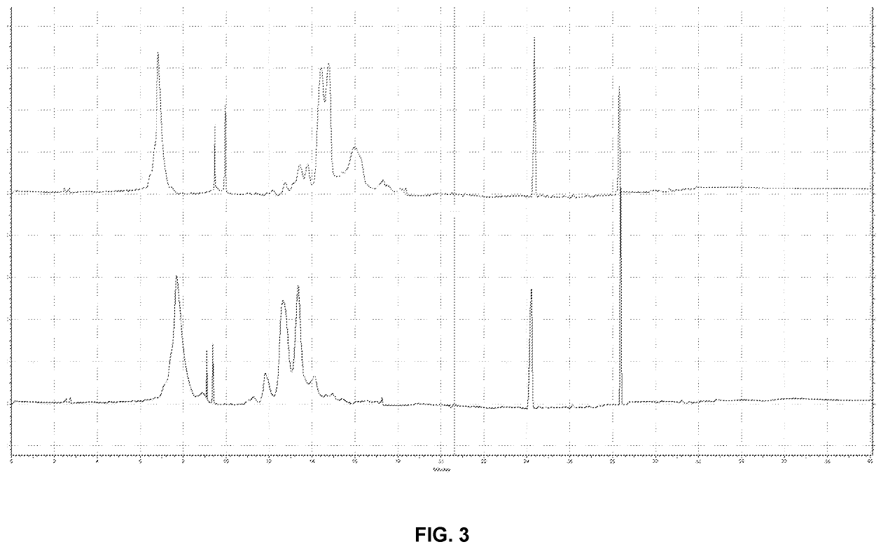

In another series of experiments, a neutral coating capillary without pre-filled cIEF gel is conditioned with dynamic coating using a polymer composition comprising polyethylene oxide (PEO), during separation runs, using peptide standard pI markers. FIG. 2 demonstrates that over the 123 test runs, the standards exhibit a wide range of detection times that are attributable to the dynamic PEO coating (no prefilling). An additional stress/drying experiment is performed on a pre-filled PEO conditioned column to assess performance. In brief, the column is subjected to accelerated shelf life conditions of storage at 55° C. for 6 days prior to separation runs. FIG. 3 illustrates that the peptide markers begin to elute from the column during the focusing step, which may demonstrate that the coating (i) is not retained in the column and/or (ii) may be failing to rehydrate sufficiently to interact with the sample.

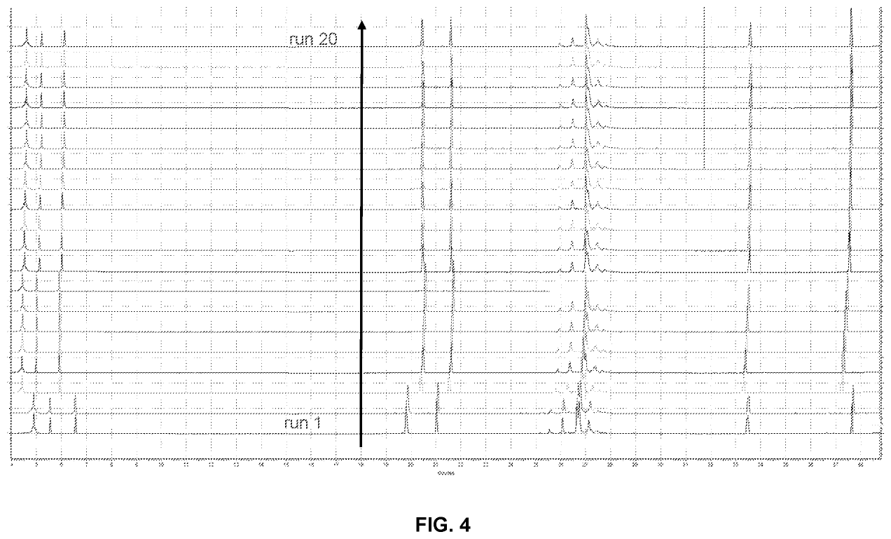

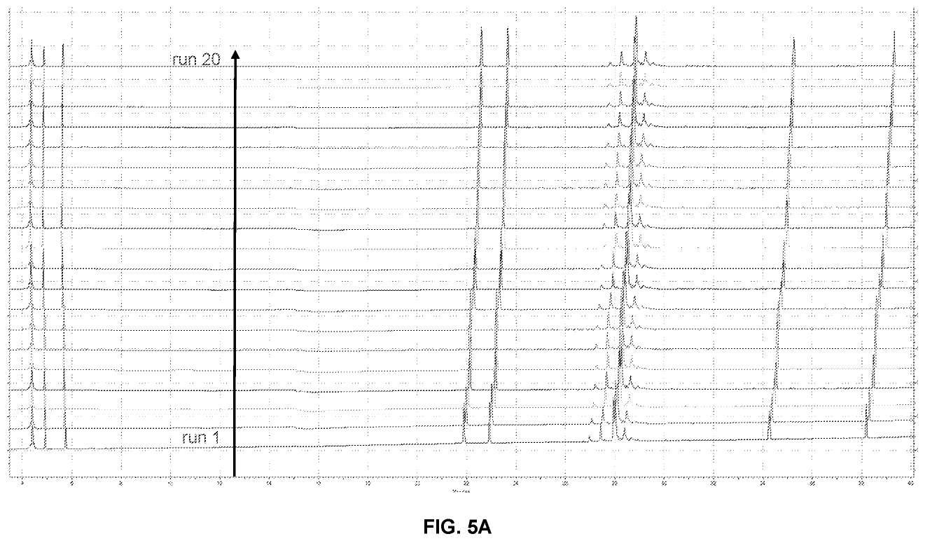

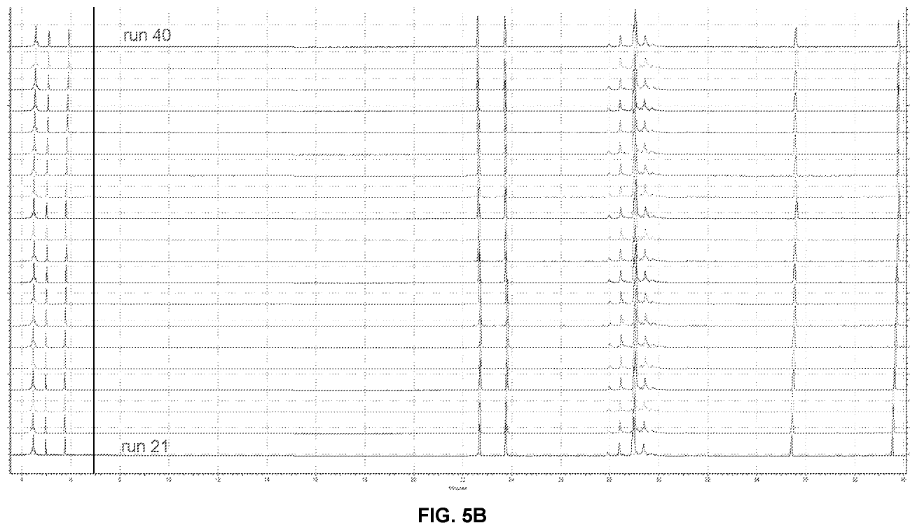

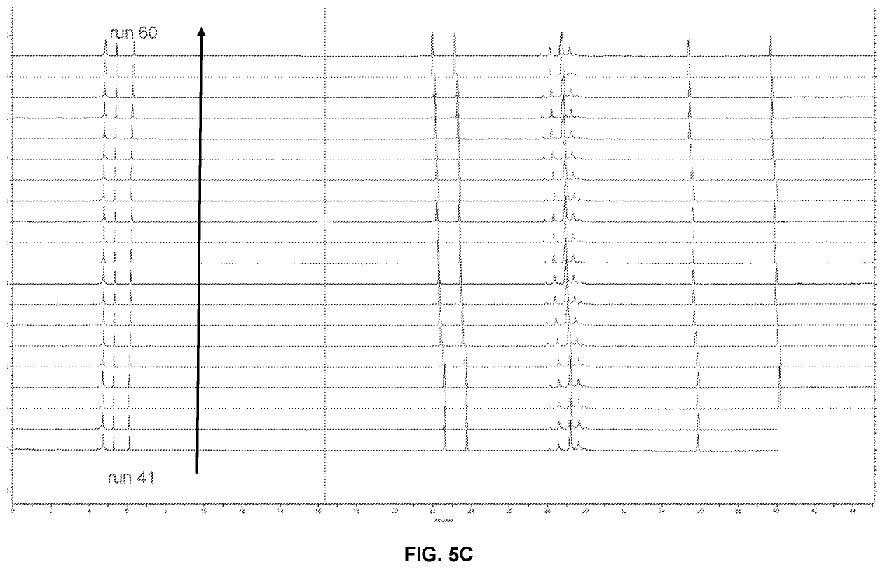

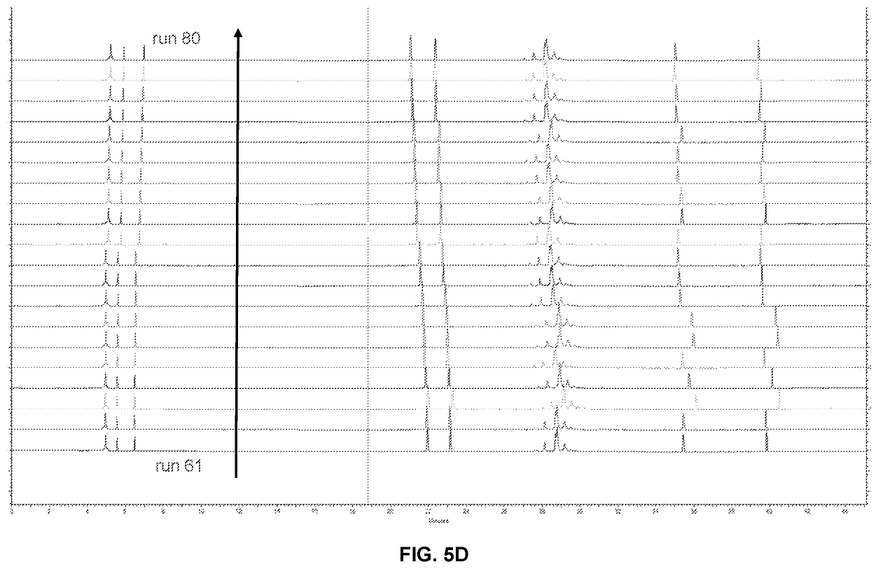

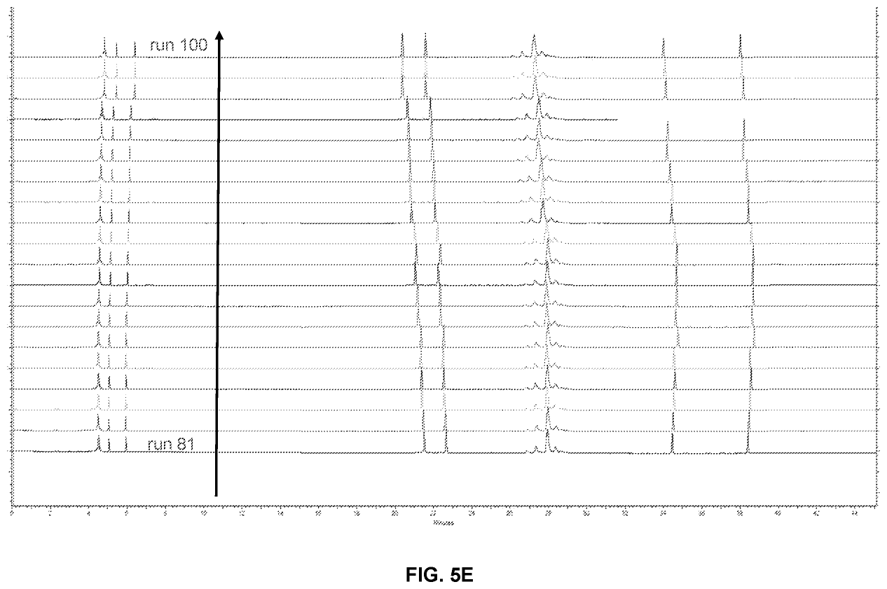

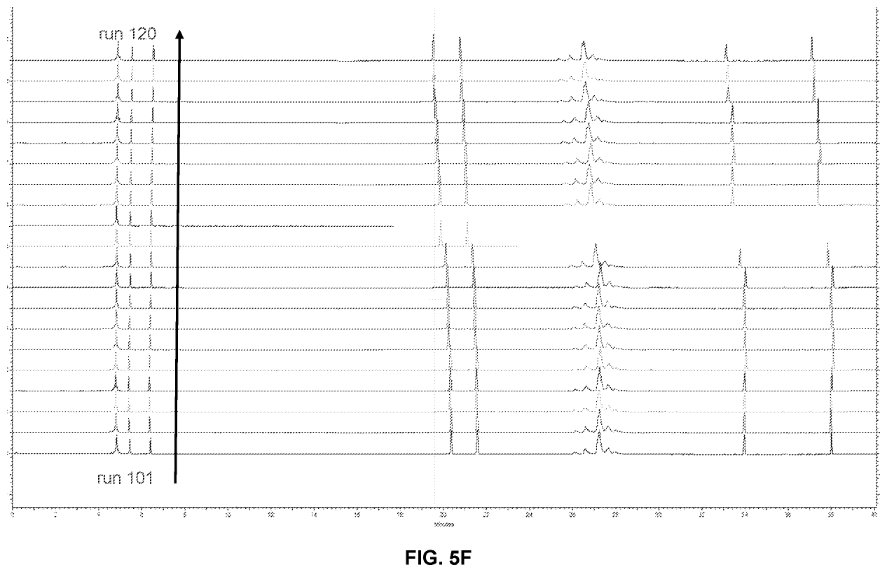

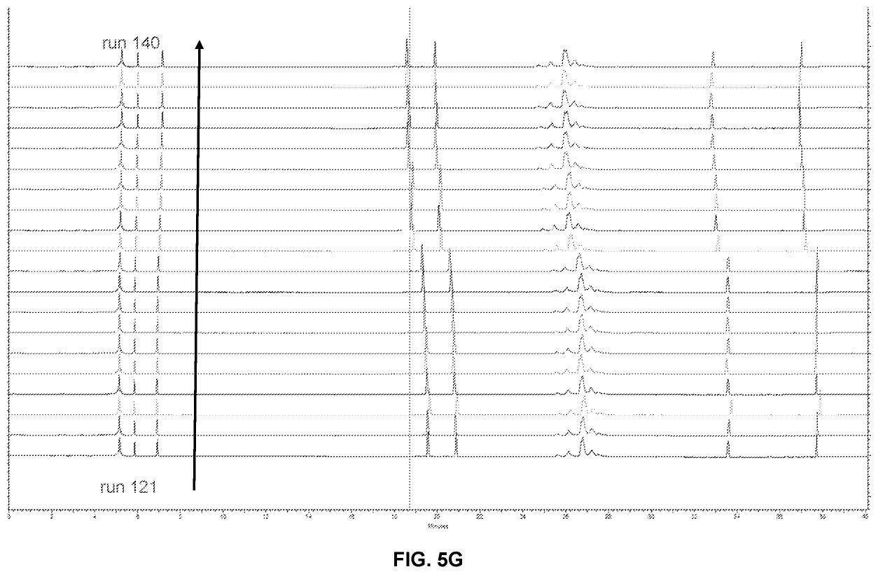

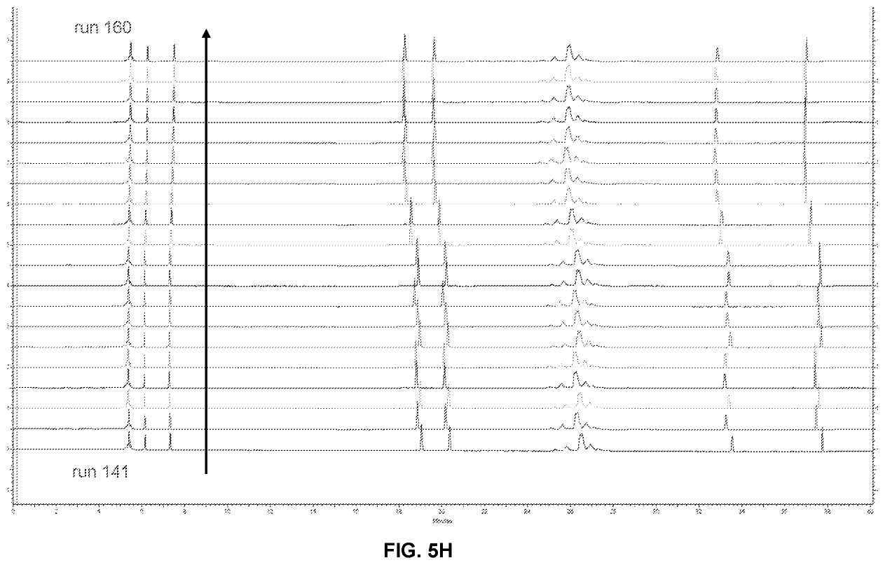

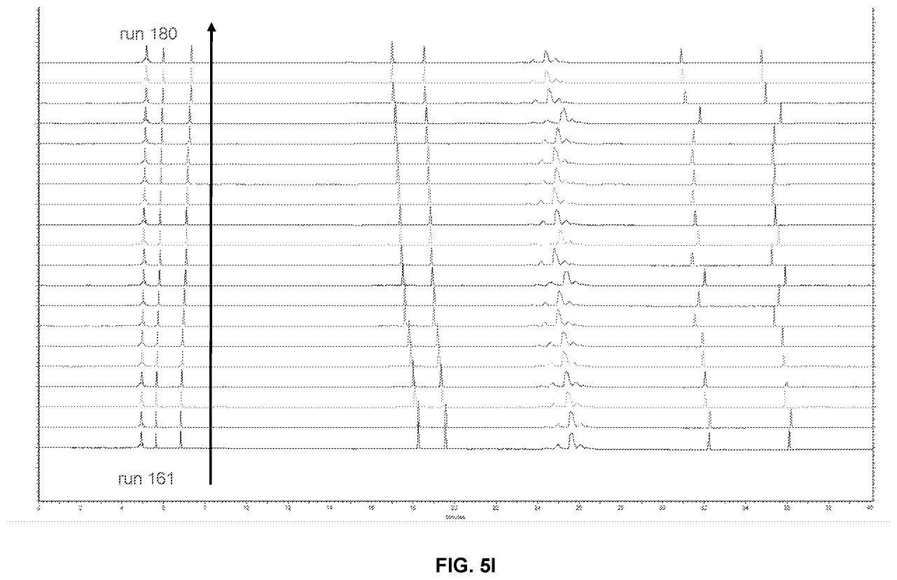

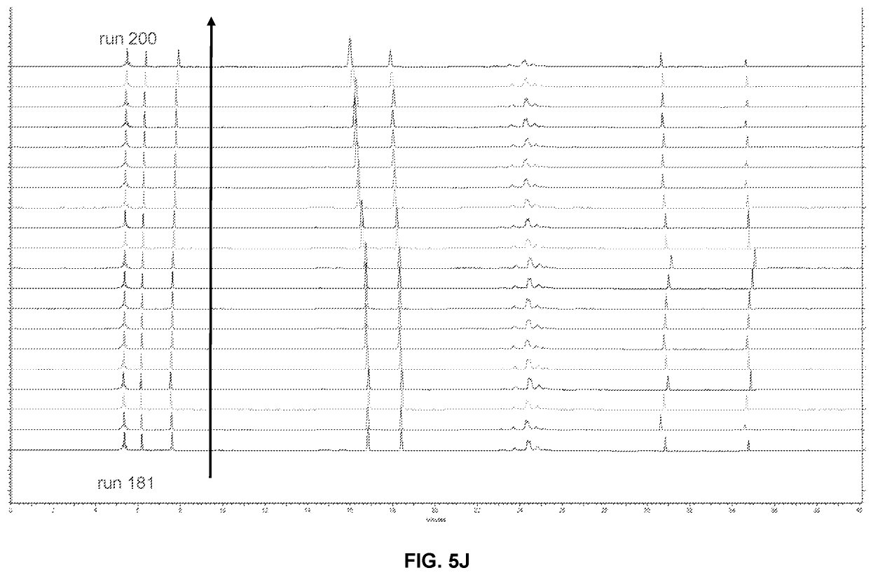

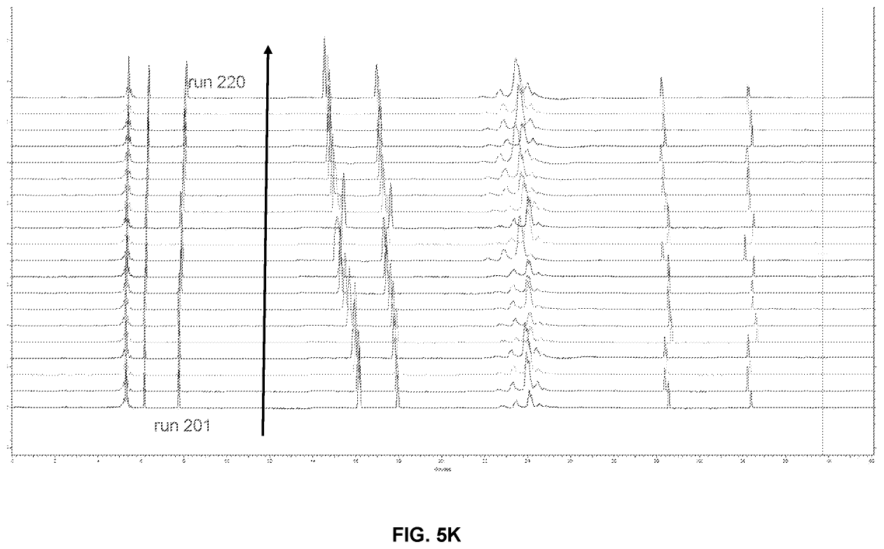

In accordance with example embodiments of the disclosure, a series of separation experiments are performed using a capillary containing a dynamic PEO coating, and conditioned with a solution comprising 10% glycerol. FIG. 4 depicts the separation achieved over 20 separations after the capillary was heated at 55° C. for 6 days without seals. Further experiments are conducted on a column containing the same PEO separation matrix, treated with 10% glycerol and stored without seals at room temperature for 10 days. Following the 10 day storage, the column was flushed out with air and stored for 6 days at 55° C. FIGS. 5A-5K demonstrates that the 10% glycerol solution was sufficient to stabilize the capillary and separations for over 200 consecutive separations. Analysis of the resolution and pI calibration over the course of the 200 separations indicates that the resolution (Rs) is <0.03 from run 5 to run 205, and a pI calibration R 2 value of 0.9997 at run 5 and 0.9994 at run 205. Effective run life in these experiments is measured using the pI 10 marker migration time—coating is considered to be failing (and the separation as failing) once the migration time of that marker is less than 15 min.

The examples illustrate that the disclosure provides for polyol solutions that confer increased stability and robustness to the coating in capillary columns. For example, polyol solutions in accordance with the disclosed aspects and embodiments provide for columns to run continuously for over 100 consecutive separations and maintain excellent sample resolution and separation characteristics over a wide range of pI values. Further the polyol solutions provide for an increased column shelf/storage life, with the accelerated thermal stress testing demonstrating an equivalent shelf life of greater than 2 years, all while performing in line with acceptable sample resolution and separation characteristics for over 100 continuous separation runs. The polyol solutions and column comprising the solutions exhibit resistance to surface coating damage, provide for column seals that are optional (not required) to maintain column integrity, and improve the useful life of the column in terms of both time and number of separations.

1. A polymer-coated capillary comprising: a capillary tube having an interior surface and an exterior surface, a polymer coating on the interior surface of the capillary tube, and a solution comprising from about 5% to about 50% of a polyol that contacts the polymer coating.

2. The polymer-coated capillary of claim 1, wherein the polymer-coated capillary is a neutral polymer-coated capillary.

3. The polymer-coated capillary of claim 1, wherein the polyol in the solution comprises a low molecular weight polyol.

4. The polymer-coated capillary of claim 1, wherein the polyol in the solution comprises a diol or a triol.

5. The polymer-coated capillary of claim 1, wherein the polyol in the solution comprises a low molecular weight glycol.

6. The polymer-coated capillary of claim 1, wherein the polyol in the solution comprises glycerol.

7. The polymer-coated capillary of claim 1, wherein the polyol in the solution comprises a viscosity of less than 30 cP.

8. The polymer-coated capillary of claim 1, wherein the capillary comprises an internal diameter of less than 3000 um.

9. The polymer-coated capillary of claim 1, wherein the solution comprises 10% of the polyol.

10. The polymer-coated capillary of claim 1, wherein the polymer-coated capillary does not comprise an end cap or seal.

11. A polyol solution for a coating on the interior surface of a polymer coated isoelectric focusing capillary tube, wherein the solution comprises from about 5% to about 50% of a polyol.

12. A pre-assembled capillary cartridge comprising at least one polymer-coated capillary, wherein the at least one polymer-coated capillary comprises an interior surface and an exterior surface, a polymer coating on the interior surface, and a solution comprising from about 5% to about 50% of a polyol that contacts the polymer coating.

13. The pre-assembled capillary cartridge of claim 12, wherein the at least one polymer-coated capillary comprises unsealed ends.

14. The pre-assembled capillary cartridge of claim 12, wherein the at least one polymer-coated capillary comprises a neutral polymer-coated capillary.

15. The pre-assembled capillary cartridge of claim 12, wherein the pre-assembled capillary cartridge comprises a plurality of polymer coated capillaries.

16. A method of manufacturing a polymer-coated capillary having improved storage capacity, the method comprising: providing a capillary tube having an interior surface and an exterior surface, wherein the capillary tube has a polymer coating on the interior surface, and contacting the polymer coating on the interior surface of the capillary tube with a polyol solution comprising from about 5% to about 50% of a polyol.

17. The method of claim 16, wherein the method further comprises drying the interior of the polymer-coated capillary after contacting with the polyol solution.

18. A kit comprising a pre-assembled capillary cartridge, wherein the capillary cartridge comprises at least one polymer-coated capillary; a solution comprising from about 5% to about 50% of a polyol; and instructions for use.

19. A kit comprising a polymer-coated capillary; a solution comprising from about 5% to about 50% of a polyol; and instructions for use.

20. The kit of claim 18, wherein the solution is disposed on an interior of the polymer-coated capillary.
